(19) United States
(12) Patent Application Publication
(10) Pub. No.: US 2026/0271171 A1
(43) Pub. Date: Sep. 10, 2026

(54) SUPERCONDUCTING UNDULATOR DEVICE

(71) Applicant: RENAISSANCE FUSION, FONTAINE (FR)

(72) Inventors: Francesco VOLPE, FONTAINE (FR); Lorenzo BORTOT, FONTAINE (FR)

(21) Appl. No.: 18/876,393

(22) PCT Filed: Jun. 22, 2023
(86) PCT No.: PCT/EP2023/067055

§ 371 Date: Dec. 18, 2024

(30) Foreign Application Priority Data
Jun. 24, 2022 (EP) 22305915.5

(51) Int. Cl. H05H 7/04; H01F 6/06; H05H 13/04

(52) U.S. Cl. CPC H05H 7/04; H01F 6/06; H05H 2007/041; H05H 13/04

(57) ABSTRACT

The present disclosure relates to an undulator device (300) comprising: —at least a first superconducting coil structure (302); and —at least a second superconducting coil structure (304) positioned opposite the first superconducting coil structure; wherein the first and second superconducting coil structures are separated by a gap (hg) dedicated to the passage of an electron beam; wherein each superconducting coil structure includes a plurality of grooves (332, 334) through the thickness (hm) of said superconducting coil structure to separate it into a plurality of elementary coils; the grooves being configured in such a way that an electrical current flowing in the superconducting coil structure between the grooves can flow alternately in two different orientations in said superconducting coil structure.

### TECHNICAL FIELD

The present disclosure relates generally to superconducting coils, more particularly to an undulator, or a wiggler, device comprising superconducting coils.

### BACKGROUND ART

There are devices in which electrons are generated, emitted and accelerated, and in which the path of the electrons may be deflected, for example to carry out experiments. A synchrotron is one of these devices. In a synchrotron, a high-energy electron beam is emitted, and the emitted electron beam may be directed into components, such as bending magnets (benders), undulator magnets (undulators) or wiggler magnets (wigglers), generally in a storage ring or a free electron laser, to produce a synchrotron radiation source (also called “synchrotron light source”). Each of these benders, undulators or wigglers supply a magnetic field adapted to change the direction of the electron beam path, for example, respectively to bend, oscillate or wiggle the electron beam. The change of direction is a form of acceleration, and, thus, the high-energy electrons may be converted into light radiation, also called “synchrotron radiation”.

Benders were first used to generate synchrotron radiation. Much better electron beam quality and significantly higher brilliance are provided by wigglers or undulators, generally in addition to benders. These two types of magnets are generally called “insertion devices”. Insertion devices are typically positioned in straight sections of a storage ring or a free electron laser.

An undulator or a wiggler typically comprises a periodic structure of dipole magnets, which can be permanent magnets or electromagnets. The periodic structure is adapted to generate a magnetic field which alternates along the length of the undulator. This alternating magnetic field is adapted to forcing the electrons of the electron beam to undulate around a beam axis corresponding to the direction of the emitted electron beam. Since the electrons undergo many changes of direction, they may be converted into light radiation of significantly higher brilliance.

The main difference between an undulator and a wiggler is the intensity of their magnetic field and the amplitude of the deviation of the electrons from the beam axis, a wiggler generally providing a stronger field than an undulator. This results in a wider horizontal opening angle of the emitted radiation, and an emission spectrum characterized by broader energy bands.

For the sake of simplicity in the description, the term “undulator” or “undulator device” can be used to designate either an undulator or a wiggler.

For certain applications, it is desired to have improvements in undulators.

### SUMMARY OF INVENTION

There is a need to provide an improved undulator device.

It would also be desirable that the undulator device is easy to implement.

One embodiment addresses all or some of the drawbacks of known undulator devices.

One embodiment provides an undulator device comprising:
at least a first superconducting coil structure; and
at least a second superconducting coil structure positioned opposite the first superconducting coil structure;
wherein the first and second superconducting coil structures are separated by a gap dedicated to the passage of an electron beam having an electron beam trajectory around a beam axis, the beam axis being in a first direction;
wherein each superconducting coil structure includes a plurality of grooves through the thickness of said superconducting coil structure to separate it into a plurality of elementary coils; the grooves being configured in such a way that an electrical current flowing in the superconducting coil structure between the grooves can flow alternately in two different orientations, for example into substantially two opposite orientations, in said superconducting coil structure.

The grooves preferably reach at least one side of the superconducting coil structure.

The undulator device may comprise a plurality of supplementary grooves through the thickness of the superconducting coil structure, the supplementary grooves being positioned at a distance from the grooves and being entirely contained inside the superconducting coil structure without reaching a side of the superconducting coil structure.

In an embodiment, the first and second superconducting coil structures extend in a direction substantially parallel to the first direction, and the gap is in a second direction substantially perpendicular to the first direction.

In an embodiment, the first and second superconducting coil structures are centered around the beam axis in the second direction, and preferably in a third direction perpendicular to the first and second directions.

In an embodiment, the alternative different orientations of the electrical current correspond to two opposite orientations in a third direction perpendicular to the first and second directions.

In an embodiment, the plurality of grooves extend in a third direction perpendicular to the first and second directions. The grooves are, for example, substantially straight.

In an embodiment, each of the grooves starts at a first side of the superconducting coil structure or a second side of the superconducting coil structure opposite the first side, and stops at a distance from respectively the second side or the first side of the superconducting coil structure, the first and second sides extending for example in the first direction.

In an embodiment, the grooves are regularly distributed in the first direction.

In a particular embodiment, the plurality of grooves comprises first grooves starting at the first side and stopping at a first distance from the second side, and second grooves starting at the second side and stopping at a second distance from the first side, the first and second grooves alternating, the first and second distances being for example equal.

In an embodiment:
the dimension, in the first direction, of each groove is higher than or equal to 0.01 mm, for example higher than or equal to 0.05 mm; and/or
the dimension, in the first direction, of each elementary coil is less than or equal to 20 mm; and/or
the dimension, in a second direction parallel to the direction of the gap, of each superconducting coil structure is less than or equal to 10 mm, preferably less than or equal to 1 mm.

In an embodiment, the at least one second superconducting coil structure is adapted to be powered with an electrical current of equal polarity with regard to the electrical current adapted to be powered in the at least one first superconducting coil structure.

In an embodiment, the grooves of the at least one first superconducting coil structure are aligned in the first direction with the grooves of the at least one second superconducting coil structure.

In an embodiment, the at least one first superconducting coil structure and/or the at least one second superconducting coil structure includes supplementary grooves through the thickness of said superconducting coil structure, the supplementary grooves being positioned at a distance from the grooves, and for example following substantially the electrical current lines between the grooves. For example, at least one of the supplementary grooves is in at least two parts.

In an embodiment, the at least one first superconducting coil structure is a first multi-structure comprising at least an inner and an outer first superconducting coil structures assembled together and the at least one second superconducting coil structure is a second multi-structure comprising at least an inner and an outer second superconducting coil structures assembled together, the first and second multi-structures being for example pairs, and for example similar pairs.

In a particular embodiment:
the first, respectively the second, inner superconducting coil structure is longer or smaller than the first, respectively the second, outer superconducting coil structure; and/or
the first, respectively the second, inner superconducting coil structure has two end grooves and two end elementary coils more or less than the first, respectively the second, outer superconducting coil structure; and/or
the first, respectively the second, inner superconducting coil structure is offset in the first direction with respect to the first, respectively the second, outer superconducting coil structure, for example of a distance equal to the sum of the dimensions in the first direction of an elementary coil of the plurality of elementary coils and of one groove of the plurality of grooves which is adjacent to the elementary coil; and/or
the first outer superconducting coil structure, respectively the second outer superconducting coil structure, is powered with an electrical current of opposite polarity with regard to the electrical current powered in the first inner superconducting coil structure, respectively the second inner superconducting coil structure.

In an embodiment:
each superconducting coil structure has at least a planar portion, preferably along the electron beam trajectory and/or
the plurality of elementary coils of each superconducting coil structure forms a serpentine shaped structure.

In an embodiment, each superconducting coil structure further comprises at least an electrical current path coupled to the plurality of elementary coils, the at least one electrical current path extending in the first direction, preferably two electrical current paths, one at each side, parallel to the first direction, of the plurality of elementary coils.

In an embodiment, the undulator device further comprises comprising a device for compensating Lorentz force on the first and second superconductive coil structures, for example a ferromagnetic collar which surrounds said first and second superconductive coil structures.

In an embodiment, each superconducting coil structure comprises, for example consists in, a stacking of different layers comprising:
a substrate layer, for example composed or covered by a material like Hastelloy;
at least a buffer layer, and preferably a plurality of buffer layers, on the substrate layer; the at least one buffer layer being for example conformed of materials like alumina, yttria, magnesium oxide and/or lanthanum manganite; and
a superconducting layer on the at least one buffer layer, the superconducting layer including a superconducting material or a material adapted to be superconducting under appropriate conditions like under a temperature limit, for example a rare-earth based material, like a rare-earth barium copper oxide, or an yttrium barium copper oxide;
the substrate layer including for example at least a canal, for example to enable a cooling fluid like nitrogen or helium flowing through the superconducting coil structure, and/or to allow wiring passing through the superconducting coil structure.

In an embodiment, the stacking comprises:
a repetition of the buffer and superconducting layers, preferably several repetitions, for example between 1 and 25 repetitions; and, possibly,
a repetition of the substrate layer and the repeated buffer and superconducting layers, preferably several repetitions, for example between 1 and 25 repetitions.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 schematically illustrates, in a general perspective view, an example of an undulator;

FIG. 2 schematically illustrates, in a cross-sectional view, an example of a superconducting undulator;

FIG. 3A schematically illustrates, in a general perspective view, a superconducting undulator according to an embodiment;

FIG. 3B schematically details, in a cross-sectional view, one of the superconducting coil structures of the superconducting undulator of FIG. 3A;

FIG. 3C illustrates partially, in a top view, one of the superconducting coil structures of the superconducting undulator of FIG. 3A.

FIG. 4 schematically illustrates, in a top view, a superconducting coil structure of a superconducting undulator according to another embodiment;

FIG. 5A schematically illustrates, in a general perspective view, a superconducting undulator according to another embodiment;

FIG. 5B schematically illustrates a detail of the superconducting undulator of FIG. 5A;

FIG. 6 schematically illustrates, in a top view, a superconducting coil structure of a superconducting undulator according to another embodiment;

FIG. 7 illustrates partially, in a general perspective view, a superconducting undulator according to another embodiment having a device for compensating Lorentz force on a superconducting coil structure;

FIG. 8A schematically illustrates, in a perspective view, a superconducting undulator according to another embodiment having another device for compensating Lorentz force;

FIG. 8B schematically illustrates, in a front view, the device for compensating Lorentz force of FIG. 8A.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the electrical connections of the coils and external power sources are not represented.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures, or to an undulator as orientated during normal use.

Unless specified otherwise, the expressions “around”, “approximately”, “substantially” and “in the order of” signify within 10%, and preferably within 5%.

In the following disclosure, a length corresponds to a dimension in the direction of the emitted electron beam (beam axis), referred as the “X” direction in the figures (longitudinal direction, or first direction), a height or a thickness correspond to a dimension in the direction that separates, perpendicularly to the beam axis, the two rows of magnets or coils or the two coil structures or coil multi-structures, referred as the “Z” direction in the figures (vertical direction, or second direction), and a width corresponds to a dimension in the direction perpendicular to the X and Z directions, referred as the “Y” direction in the figures (transversal direction, or third direction). In the following disclosure, the electron beam trajectory is substantially in a plane parallel to the first and third directions X, Y.

The figures are not to scale. It should be noted that the figures refer to an embodiment of the disclosed undulator, sometimes also referred simply as device, when no ambiguity is anticipated. Other embodiments may be possible, as someone with appropriate training may readily appreciate. The actual dimension and/or shape of each of the components of the embodiments may vary. Only important details of the embodiment are shown, however one of ordinary skill in the art can appreciate how the overall device may be constructed, without undue experimentation. Some details may have been omitted from the figures, but the inventors believe that adding these details is unnecessary for the overall appreciation of the characteristics of the embodiments disclosed. These omitted details include, among others, elements for holding or fixing or for electrically supplying the device and/or its functional components. Some characteristics of the embodiments appear exaggerated to facilitate understanding.

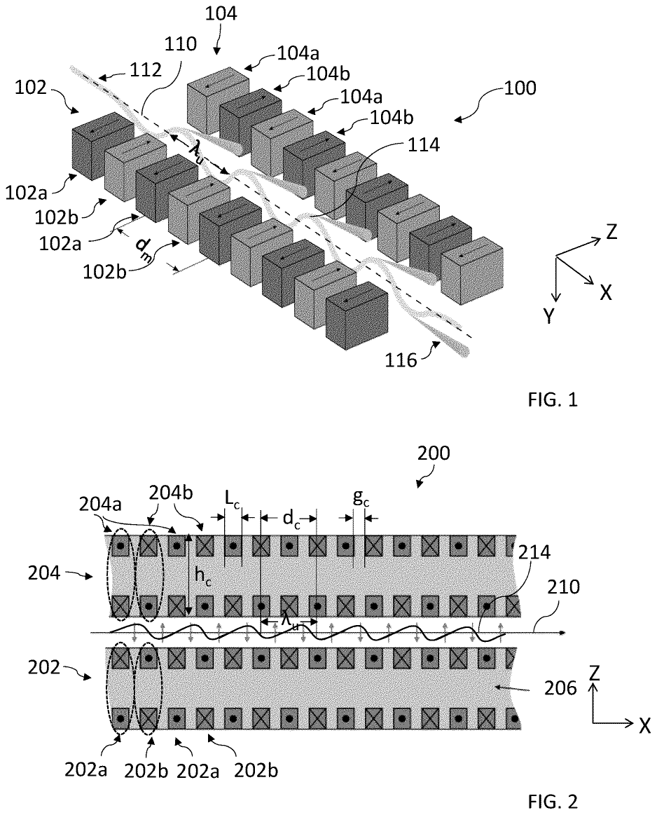

A simplified example of an undulator 100 is shown in FIG. 1. An electron beam 112 with an initial emission path corresponding to a beam axis 110, in the X direction, is injected into the undulator 100. The undulator 100 comprises a first row 102 of magnets 102a, 102b and a second row 104 of magnets 104a, 104b that is apart from and opposes the first row 102 of magnets, the beam axis 110 being between the first row and the second row. The two rows of magnets 102, 104 induce a magnetic field between them. The magnets have preferably the same dimensions and can be permanent magnets or electromagnets.

First sets of magnets 102a, 104a, with left pointing arrows, are configured to create a first magnetic field contribution with field lines between said magnets mainly orientated in a first orientation, while second sets of magnets 102b, 104b, with right pointing arrows, are configured to create a second magnetic field contribution with field lines between said magnets mainly orientated in a second orientation opposite the first orientation. The first and second sets of magnets alternate each other.

Therefore, the magnets are configured in a periodic structure which can be defined by the distance dₘ in the X direction between the centers of two adjacent first sets of magnets or between the centers of two adjacent second sets of magnets.

As the electrons travel between the first row 102 of magnets and the second row 104 of magnets, they travel from the first magnetic field contribution to the second magnetic field contribution and from the second magnetic field contribution to the first magnetic field contribution alternatively through the undulator device 100, and the periodic reversing or switching of the magnetic field orientation causes the trajectory of the electrons to oscillate, or undulate, as illustrated by the oscillatory trajectory 114. The periodic magnetic field, and substantially the oscillation, have a spatial periodicity λᵤ which is defined by the distance dₘ. By changing the direction or the trajectory of the electrons, the periodic magnetic field accelerates the electron in an oscillatory pattern. As a result, the electrons emit electromagnetic radiation 116 defined by the oscillatory trajectory 114. This radiation may be guided through one, or a plurality, of beam line(s), for example to carry out experiments (not represented).

Improvements can be brought to undulators, in particular to increase the peak magnetic field applied to the electrons, and at the same time to reduce the size and the weight of an undulator, without degrading the quality of magnetic field at the beam axis. Reducing the distance dₘ is particularly desirable to make an undulator more compact, and thus, to gain more available space in a storage ring or a free electron laser, that is, to gain more space which is not occupied by the undulator, and which can be used for experiments or diagnostics, for example. Such improved undulators can be achieved with superconducting technology, for example using superconducting coils. These undulators may be called superconducting undulators.

FIG. 2 is an example of a superconducting undulator 200. The superconducting undulator 200 comprises a first row 202 (lower row) of coils 202a, 202b (lower coils) and a second row 204 (upper row) of coils 204a, 204b (upper coils) that is apart from and opposes the first row 202 of coils, the beam axis 210 being between the first row and the second row. The coils 202a, 202b, 204a, 204b are superconductive coils. In the example of FIG. 2, the coils 202a, 202b, 204a, 204b are inserted in an iron frame 206, for example in slots in the iron frame. In a variant, the coils of each row of coils may be separated by iron poles.

First sets of coils 202a, 204a are configured to create a first magnetic field contribution with field lines between the two rows mainly orientated in a first orientation, while second sets of coils 202b, 204b are configured to create a second magnetic field contribution with field lines between the two rows mainly orientated in a second orientation opposite the first orientation, as shown by the vertical arrows in FIG. 2. The first and second sets of coils alternate each other.

The periodic structure of the coils can be defined by the distance d_{c} in the X direction between the centers of two adjacent first sets of coils or between the centers of two adjacent second sets of coils.

As the electrons travel between the first row 202 of coils and the second row 204 of coils, they travel from the first magnetic field contribution to the second magnetic field contribution and from the second magnetic field contribution to the first magnetic field contribution alternatively through the undulator device 200, the periodic reversing or switching of the magnetic field orientation causes the trajectory of the electrons to oscillate (undulate) as illustrated by the oscillatory trajectory 214. The periodic magnetic field, and substantially the oscillation, have a spatial periodicity λᵤ which is defined by the distance d_{c}.

An advantage of this undulator is that the electrical current that creates the periodic magnetic field can have the same amplitude in each set of coils along the length of the undulator device. Therefore, the magnetic field contribution generated by each set of coils can have substantially the same amplitude along the length of the undulator device, with opposite orientations depending if it is generated by a first set of coils or by a second set of coils. If the coils are geometrically and electrically identical, and the iron frame or poles shows homogeneous magnetic behavior, then the periodic magnetic field generated in the undulator can be close to ideal.

One limitation of such an undulator having superconducting coils is the size of the coils, in particular the height h_{c} may be important, which can decrease or limit the peak magnetic field applied to the electrons. The length L_{c} of the coils in the X direction can also be a limiting dimension, since this dimension, together with the distance, or gap, g_{c} between two adjacent coils, in the X direction, defines the spatial periodicity λᵤ. Indeed, the distance d_{c} corresponds to two times the sum of the length L_{c} and the gap g_{c}.

Another limitation is given by the use of superconducting coils with a high aspect ratio, such as tapes, because the field quality at the beam axis can be severely degraded by the magnetic field contribution of persistent eddy currents occurring in tapes.

In addition, the coils have preferably to be geometrically and electrically identical, as explained above. However, this is not straightforward for such coils to be all identical.

Moreover, it is desirable to avoid the use of ferromagnetic materials in the generation of the magnetic field, to avoid issues related to saturation and inhomogeneity of the material properties which may lead to degradation of the magnetic field quality.

The inventors propose an undulator making it possible to overcome all or part of the aforementioned drawbacks, in particular to increase the peak magnetic field which can be applied to the electrons, for example up to around 1 Tesla (T), or even up to 1.5 T.

Advantageous, the inventors propose an undulator that can adapt the spatial periodicity λᵤ to the peak magnetic field and/or that can decrease the spatial periodicity λᵤ, for example in order to leave the electron trajectory as unperturbed, despite a possible increase of the magnetic field. Consequently, in a synchrotron application, the spectrum of the emitted synchrotron light remains within narrow energy bands, which is desirable for the undulator performance.

Embodiments of undulators will be described below. These embodiments are non-limiting and various variants will appear to the person skilled in the art from the indications of the present description.

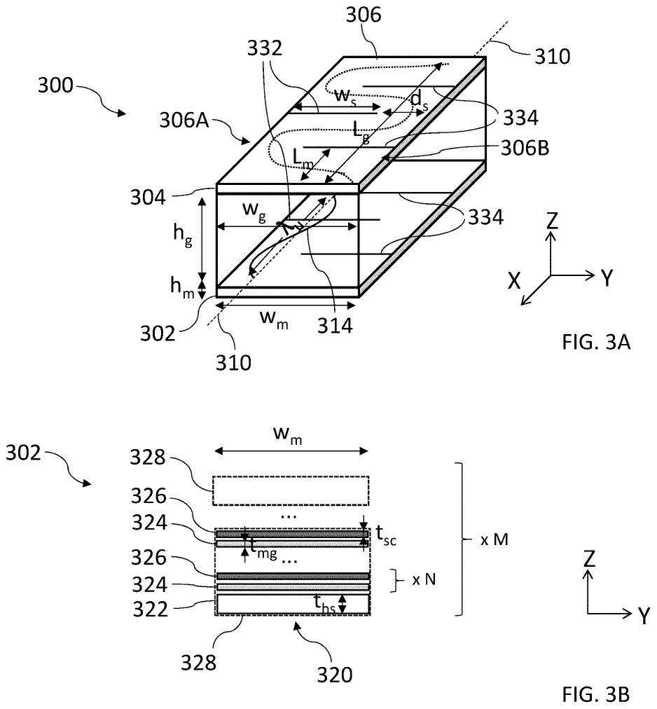

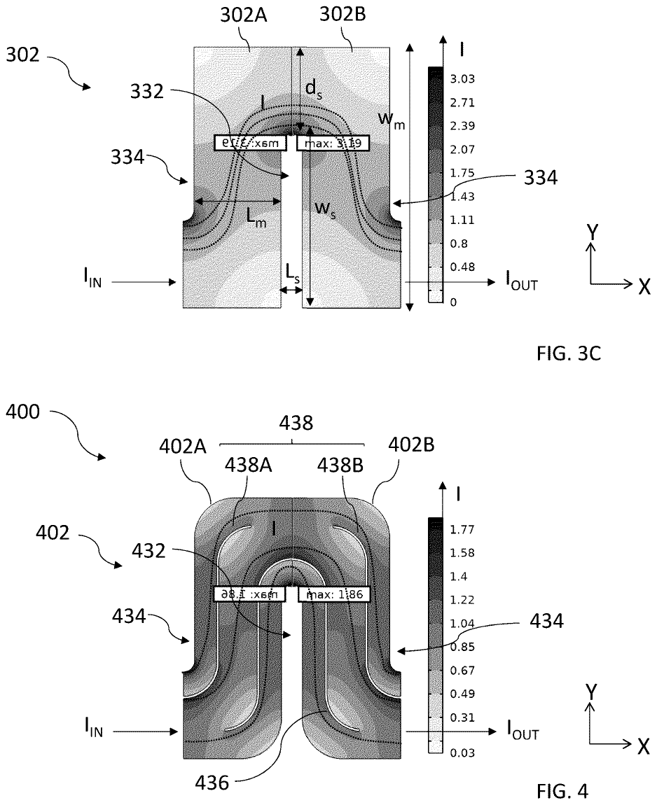

FIG. 3A schematically illustrates, in a general perspective view, a superconducting undulator 300 (undulator device) according to an embodiment. FIG. 3B schematically details, in a cross-sectional view, a superconducting coil structure 302 of the superconducting undulator 300 of FIG. 3A. FIG. 3C illustrates partially, in a top view, the superconducting coil structure 302 of FIGS. 3A and 3B.

The superconducting undulator 300 comprises a first superconducting coil structure 302 (lower coil structure) and a second superconducting coil structure 304 (upper coil structure) which is positioned opposite the first superconducting coil structure 302, the first and second coil structures being separated by a distance (gap) h_{g} in the Z direction which is a design parameter and depends on the required peak magnetic field at the beam axis 310, the spatial periodicity λᵤ, and the physical properties of the electron beam.

The beam axis 310, corresponding to the direction of the emitted electron beam, is represented in the X direction, and it is preferably centered in the Y and Z directions with respect to the first 302 and second 304 coil structures. The electron beam oscillates around the beam axis 310 in the XY plane along an electron beam trajectory 314, due to Lorenz force.

For sake of simplicity in the description, each superconducting coil structure may be called “coil structure”, and the superconducting undulator may be called “undulator” or “undulator device”.

The length direction of the undulator device corresponds to the length direction of the superconducting coil structures.

The first 302 and second 304 coil structures are preferably similar.

As illustrated in FIG. 3B, each superconducting coil structure may comprise, for example consist in, a stacking 320 of different layers. Only coil structure 302 is referred in FIG. 3B, but it can apply also to coil structure 304.

The stacking 320 comprises a substrate layer 322 composed of a material like Hastelloy or a material constructed out of a different material, for example another nickel alloy, and covered by Hastelloy.

The substrate layer 322 may include at least one canal (not represented), in which cooling agents may flow to allow cooling of the whole coil structure. In particular, the superconducting layer 326, detailed below, may require adequate cooling during operation.

On the substrate layer 322, there is preferably a buffer layer 324, which may be a structure of several stacked buffer layers. The buffer layer(s) may be conformed of one or several materials like alumina, yttria, magnesium oxide and lanthanum manganite. The buffer layer(s) may be deposited through a technique like sputtering, before depositing the superconducting layer 326. The buffer layer(s) may form an appropriate template for the formation of the superconducting layer 326 described below.

On the buffer layer 324, is located a superconducting layer 326. The superconducting layer 326 may be composed of rare-earth barium copper oxide (REBCO) or yttrium barium copper oxide (YBCO) or other appropriate superconducting materials. The superconducting layer 326 may be deposited through a technique like metal-organic chemical vapor deposition (MOCVD).

A metal layer, for example a silver layer, may be deposited on the superconducting layer (not represented in FIG. 3B). The metal layer may form a shunt layer offering a path to electrical current, for example in case one or more superconducting layers suffer a localized transition from the superconducting to the normal conducting state, commonly referred to as quench.

The described sequence of buffer and superconducting layers, and possibly of the metal layer, may be repeated N times, for example around 10 times, forming a layering 328 on the substrate layer 322. In other words, several sequences of buffer and superconducting layers may be deposited on the substrate layer 322.

Combining multiple layers (tapes) in one allows reducing the achievable minimum thickness of the tape stacking. The same electrical current can flow in a thinner coil, being closer to the beam axis 310, producing as a consequence a higher magnetic field.

The described layering 328 comprising the substrate layer and the sequence of buffer and superconducting layers, and possibly of the metal layer, repeated N times, may form the stacking or may also be repeated M times to form the stacking 320. In this last case, a plurality of layerings 328 may be formed and stacked on top of each other; or the layering may be long enough, like a tape, and rolled up on itself in the length direction, M turns corresponding to M stacked layerings.

Other details or variants of the superconducting coil structures of the superconducting undulator according to an embodiment, and methods for fabricating said superconducting coil structures may be found in European patent application number EP22305437, filed on Apr. 4, 2022 by the same applicant “RENAISSANCE FUSION”, entitled “METHOD FOR MANUFACTURING SUPERCONDUCTING COILS AND DEVICE”, which is hereby incorporated by reference to the maximum extent allowable by law.

As illustrated in FIG. 3A, each superconducting coil structure 302, 304 is substantially planar and extends in a plane XY in a rectangular shape 306. In other words, each superconducting coil structure forms a parallelepipedal structure.

This is non-limiting shape and a superconducting coil structure may have many other shapes, like a disc shape or a free-form shape. Each superconducting coil structure may also be at least partially curved instead of being completely planar. Preferably, the superconducting coil structures have planar portions along the electron beam trajectory 314.

Whatever the shape, the height hₘ of each coil structure is preferably thin, typically less than around 10 mm, or even less than around 1 mm, particularly thanks to the stacking structure.

The thin height hₘ of each coil structure allows reducing the distance in the Z direction between the center of each coil structure 302, 304 and the beam axis 310, since the distance in the Z direction between the center and the edges of each coil structure is reduced. Consequently, it allows increasing the peak magnetic field applied to the electron beam, since the peak magnetic field increases when the distance with the coil which generates the magnetic field decreases.

In each superconducting coil structure 302, 304, grooves 332, 334 are created through the coil structure so as to separate the coil into different parts, forming several elementary coils along the length L_{g} of the coil structure, as illustrated in FIG. 3C. FIG. 3C is a partial top view of the superconducting coil structure 302 and represents only two elementary coils 302A, 302B, but there are preferably more than two elementary coils in each superconducting coil structure. Each groove traverses all the thickness of the coil structure. A groove may also be called a slit.

The grooves may be formed using a patterning method, preferably like laser patterning or engraving, or another technique, like a mechanical technique or photolithography.

The grooves of each superconducting coil structure are configured in such a way that the electrical current I (represented by the dotted lines in FIGS. 3A and 3C) flowing in the coil structure between these grooves can flow alternately in two different orientations, preferably into substantially two opposite orientations, in the coil structure, so as to be able to create a magnetic field whose direction is periodically changed, preferably reversed along the X direction, with a spatial periodicity λᵤ.

As the electrons from the emitted electron beam travel in the X direction through the undulator device 300, they undergo the periodic magnetic field which causes the trajectory of the electrons to oscillate (undulate) around the beam axis 310, as illustrated by the oscillatory trajectory 314, which is in the plane parallel to the directions X, Y.

It is specified that, when it is indicated that the electrical current can flow alternately in two different, or even opposite, orientations, this does not exclude that the electrical current can flow in other directions or orientations in the coil structure, knowing that these two different, or even opposite, orientations of the electrical current are those of interest, since it is these different orientations of the electrical current that makes it possible to obtain the periodic magnetic field of interest (that is, the Z component of the magnetic field).

In a particular embodiment, the alternative opposite orientations of the electrical current I may be in the width direction of the coil structure (Y direction). For example, as detailed after, the grooves 332, 334 may extend in the width direction of the coil structure. The grooves 332, 334 may be substantially straight.

The grooves 332, 334 may be regularly distributed along the beam axis, that is, in the X direction.

The grooves 332, 334 of the first coil structure 302 are preferably aligned with the grooves 332, 334 of the second coil structure 304 in the X direction.

The second coil structure 304 is powered with an electrical current of equal polarity with regard to the electrical current powered in the first coil structure 302, in order to combine the Z components of the magnetic fields generated by the two coil structures at the beam axis, and not to cancel them. Ideally, this may decrease or even cancel the Y component of the magnetic field.

In the illustrated superconducting coil structures 302, 304, the grooves 332, 334 extend in the Y direction of the plane XY, which is the direction perpendicular to the beam axis, that is, the X direction. The grooves 332, 334 are formed along a partial width of each superconducting coil structure 302, 304, that is, not along the entire width. In other words, each groove 332, 334 stops at a distance dₛ from one of the long sides of the rectangular-shaped coil structure. The width wₛ of each groove is defined by the difference between the width wₘ of the coil structure and the distance dₛ.

First grooves 332 start from a first long side 306A of the rectangle and stop at a distance dₛ from the second long side 306B of the rectangle, and second grooves 334 start from the second long side 306B and stop at the same distance dₛ from the first long side 306A of the rectangle, the first and second grooves alternating, so that the path created for the electrical current I between the grooves is substantially a meandering/undulatory path.

The distances dₛ of the first grooves and second grooves from respectively the second and first long side are represented equal, but this is not limiting and they may be different.

The distances Lₘ between adjacent first 332 and second 334 grooves are preferably regular along the length of the coil structure, and preferably equal to the distance dₛ, but this is not limiting and they may be different.

This distance Lₘ corresponds to the length of each elementary coil. Therefore, if this distance Lₘ is regular along the length of the coil structure, given that the width of each elementary coil corresponds substantially to the width wₘ of the coil structure, then the elementary coils formed by the grooves may be geometrically identical. In addition, since the same electrical current I flows between the grooves in each coil structure, the electrical current that creates the magnetic field is the same in each elementary coil.

In addition, the length Lₘ of the elementary coils can be adapted, by adapting the positioning of the grooves.

Moreover, the distance between the elementary coils can be adapted, for example decreased, by adapting the length Lₛ of the grooves (Lₛ represented in FIG. 3C).

The width wₘ of each superconducting coil structure may be more than 20 mm, for example more than, or equal to, around 30 mm, or even more than, or equal to, around 50 mm.

The spatial periodicity λᵤ is defined by two times the sum of the length Lₘ of an elementary coil and the length Lₛ of a groove.

For example, the length Lₛ of the grooves is higher than, or equal to, around 0.01 mm, or higher than, or equal to, 0.05 mm, or even higher than, or equal to, around 0.1 mm. For example, the distance Lₘ between adjacent grooves is less than, or equal to, around 20 mm.

An example of dimensions of a superconducting undulator according to an embodiment is given in Table 1 below

TABLE 1

| | | | |
|---|---|---|---|
| Spatial periodicity | λᵤ | 10 | mm |
| Gap height | h_{g} | 5 | mm |
| Gap width | w_{g} | 100 | mm |
| Gap length (coil structure | L_{g} | 1000 | mm |

length)

An example of dimensions of a superconducting coil structure in a superconducting undulator according to an embodiment is given in Table 2 below.

TABLE 2

| Coil structure/elementary coils width | wₘ | 100 | mm |
|---|---|---|---|
| Elementary coils length | Lₘ | 4 | mm |
| Grooves width | wₛ | 96 | mm |
| Grooves distance | dₛ | 4 | mm |
| Grooves length | Lₛ | 1 | mm |
| Number of layers (layering) | N | 10 | |
| Number of layerings (stacking) | M | 10 | |
| Substrate thickness | tₕₛ | 25 | μm |
| Buffer thickness | t_{mg} | 1 | μm |
| Superconductor thickness | t_{sc} | 1 | μm |

FIG. 4 schematically illustrates, in a top view, a superconducting coil structure 402 of a superconducting undulator 400 according to another embodiment.

The superconducting coil structure 402 of FIG. 4 differs from the superconducting coil structure 302 of FIG. 3C mainly in that each elementary coil 402A, 402B includes at least one supplementary groove between the grooves 432, 434, two supplementary grooves 436, 438 in the illustrated example. The supplementary grooves 436, 438 are positioned in order to reduce the undesired inhomogeneity in the electrical current lines flowing in the coil structure between the grooves. In the illustrated example, the supplementary grooves 436, 438 follow substantially the shape of electrical current lines between the grooves 432, 434 and are positioned at different distances from said grooves. The supplementary grooves can be curved, as illustrated in FIG. 4.

Indeed, as illustrated in FIG. 3C by the darkest zones, corresponding to zones where the electrical current has the most important amplitude, as can be seen in the rule at the right of the figure, without the supplementary grooves, the electrical current preferentially flows through the shortest paths between the grooves. Therefore, the electrical current lines tend to be concentrated around these shortest paths, which may lead to an inhomogeneous distribution of electrical current lines in each elementary coil, and to an inhomogeneous magnetic field distribution. The supplementary grooves force the electrical current to take other paths, as illustrated in FIG. 4 where it can be seen that the darkest zones are better distributed. This leads to a more homogeneous magnetic field distribution, and may improve the quality in the magnetic field produced by the undulator, for example closer to a perfect sinusoid.

The supplementary groove(s) may also have the advantage of providing an impedance to the circulation of eddy currents within the superconducting layer(s) in the superconducting coil structure, therefore they may be beneficial for the magnetic field quality at the beam axis

The supplementary grooves differ from the grooves in that the additional grooves are entirely contained inside the superconducting coil structure, that is, do not reach a side of the superconducting coil structure, whereas the grooves reach at least one side of the superconducting coil structure.

The dimensions of the supplementary grooves in the first direction X may be significantly lower than the length Lₛ of the grooves.

One supplementary groove 438 may be in two parts 438A, 438B to allow for electrical current redistribution, for example in case of a quench.

The superconducting coil structure 402 of FIG. 4 also differs from the superconducting coil structure 302 of FIG. 3C in that the grooves 432, 434 are patterning in order to round the edges of the elementary coil 402A, 402B. This feature is not necessary linked to the presence of the supplementary grooves 436, 438.

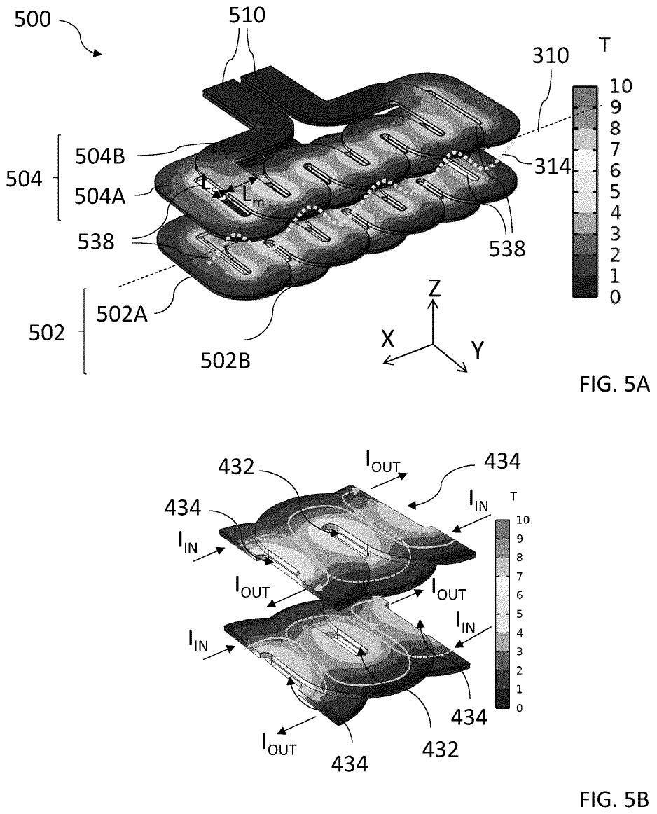

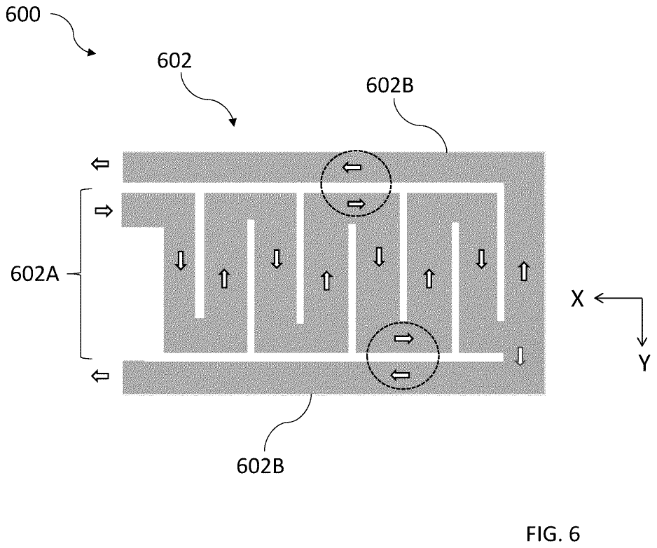

As seen in FIGS. 3C, 4, and also in FIGS. 5A, 5B, and 6 described below, the plurality of elementary coils of each superconducting coil structure may form a serpentine shaped structure.

FIG. 5A schematically illustrates, in a general perspective view, a superconducting undulator 500 according to another embodiment. FIG. 5B schematically illustrates a detail of the superconducting undulator 500 of FIG. 5A.

The superconducting undulator 500 of FIGS. 5A and 5B differs from the superconducting undulator 300 of FIG. 3A mainly in that, instead of having a first coil structure 302 facing a second coil structure 304, there is a first pair 502 of first coil structures 502A, 502B (lower coil structures) assembled together facing a second pair 504 of second coil structures 504A, 504B (upper coil structures) assembled together. The first 502 and second 504 pairs of coil structures are separated by a distance which is a design parameter and depends from the required peak magnetic field at the beam axis 310, the spatial periodicity λᵤ, and the physical properties of the electron beam. The beam axis 310 is represented in the X direction, and it is centered in the Y and Z direction with respect to the pairs 502, 504 of coil structures. The electron beam oscillates around the axis 310 in the XY plane along the electron beam trajectory 314.

More precisely, the first coil structures 502A, 502B consist in a first inner coil structure 502A (closest to the beam axis 310) assembled with a first outer coil structure 502B (farthest from the beam axis 310), and, similarly, the second coil structures 504A, 504B consist in a second inner coil structure 504A assembled with a second outer coil structure 504B.

The coil structures 502A, 502B, 504A, 504B are preferably similar, for example similar to the coil structures 302, 304 described above, except that the inner coil structures 502A, 504A have two end grooves 538A, and two end elementary coils, more than the outer coil structures 502B, 504B. The end grooves, respectively the end elementary coils, means the grooves, respectively the elementary coils, positioned at the ends of the inner coil structures in the longitudinal direction X.

In the example, the inner coil structures 502A, 504A are longer than the outer coil structures 502B, 504B, but this is not necessary. For example the outer coil structures 502B, 504B could be longer than the inner coil structures 502A, 504A.

When assembled together, the first, respectively the second, inner and outer coil structures are offset by a distance substantially equal to the sum of the length Lₘ of an elementary coil and the length Lₛ of an adjacent groove, that is, half the spatial periodicity λᵤ, so that the serpentine shape of the first, respectively the second, outer coil structure is reversed with respect to the serpentine shape of the first, respectively the second, inner coil structure.

Therefore, as illustrated in FIG. 5B, it is necessary that the first outer coil structure is powered with an electrical current of opposite polarity with regard to the electrical current powered in the first inner coil structure, in order to avoid cancelling the electrical currents in the Y direction, and instead to combine them. The same applies to the second inner and outer coil structures.

The grooves 432, 434 of the first outer structure 502B are aligned in the X direction with the grooves 432, 434 of the first inner structure 502A which are not at its ends, and the grooves 432, 434 of the second outer structure 504B are aligned in the X direction with the grooves 432, 434 of the second inner structure 504A which are not at its ends.

The grooves 432, 434 of the second pair 504 of coil structures are preferably aligned with the grooves 432, 434 of the first pair 502 of coil structures in the X direction.

The second pair 504 of coil structures is powered with an electrical current of equal polarity with regard to the electrical current powered in the first pair 502 of coil structures.

This embodiment can allow for compensating for an undesired magnetic field error which may appear with only two coil structures as in FIG. 3A, for example to reduce or even cancel the horizontal magnetic field components, that is, in the XY plane in FIGS. 5A and 5B.

In addition, the coil terminals 510, that is the terminals which allow the electrical current to arrive in the coil structures and/or to leave the coil structures, of the inner coil structure 502A, 504B are at a same position than the coil terminals 510 of the outer coil structure 502B, 504B, for each pair 502, 504 of inner and outer coil structures. Therefore, the electrical currents of the inner and outer coil structures can arrive and return in a substantially same area and direction. This configuration can reduce undesired magnetic field which may be produced otherwise by the coil terminals.

In the example of FIGS. 5A and 5B, two pairs, each of two superconducting coil structures are represented. This is not limitative and, instead of a pair, it could be a multi-structure of more than two superconducting coil structures. Preferably, at least two different superconducting coil structures of each multi-structure are offset of about half the spatial periodicity λᵤ in the X direction.

FIG. 6 schematically illustrates, in a top view, a superconducting coil structure 602 of a superconducting undulator 600 according to another embodiment.

The superconducting coil 602 of FIG. 6 differs from the superconducting coil 302 of FIG. 3A mainly in that it includes electrical current paths 602B in the X direction coupled to, and extending at both longitudinal sides of, a central serpentine coil structure 602A.

This configuration allows decreasing, or even cancelling out, the electrical current in the X direction and therefore the Y component of the magnetic field. Indeed, mainly the Z component of the magnetic field is of interest. This also makes it possible not to necessarily have multi-structures of two or more superconducting coil structures to obtain the same effect.

The electrical current is represented by small arrows. FIG. 6 shows a specific polarity of the electrical current but it could be the opposite polarity. For example, instead of entering in the central serpentine coil structure 602A and exiting through the electrical current paths 602B, the electrical current could enter in the electrical current paths 602B and exit through the central serpentine coil structure 602A.

FIG. 7 illustrates partially, in a general perspective view, a superconducting undulator according to another embodiment. The superconducting undulator 700 of FIG. 7 differs from the superconducting undulator 300 of FIG. 3A mainly in that it comprises a device 740 for compensating Lorentz force on a coil structure.

The device 740 comprises, for example consists in, a pole made of a ferromagnetic material which is added close to, or on, the outer side of each coil structure (the inner side of a coil structure corresponds to the side which faces the beam axis, and the outer side corresponds to the side opposite the inner side). Only the pole on the outer 304B side (opposite the inner side 304A) of the second coil structure 304 is represented, but another pole is preferably also added close to, or on, the outer side of the first coil structure 302. The poles can be made for example of iron, nickel, or cobalt.

The ferromagnetic poles are adapted to attract the coils, compensating for the Lorentz force contribution.

The effect of each pole may be parametrized by its width wₚ and/or its length Lₚ, and also by the coil-pole distance dₚ. The coil-pole distance dₚ may be null or may be for example equal to around 1 mm. The width wₚ of the pole may depend on the width wₘ of the coil structure to which the pole is added. The length Lₚ of the pole may also depend on the length of the coil structure to which the pole is added. For example, the width wₚ of the pole is comprised between 50 and 100 mm, and the length Lₚ of the pole is comprised between 500 and 1500 mm. The thickness of the pole may have less influence on the attraction effect if the ferromagnetic material is not magnetically saturated, and may be, for example, around 10 mm.

Other shapes and/or dimensions of the ferromagnetic poles may be designed to compensate for the Lorentz force contribution. Also, the ferromagnetic poles may be positioned differently with respect to the coil structures.

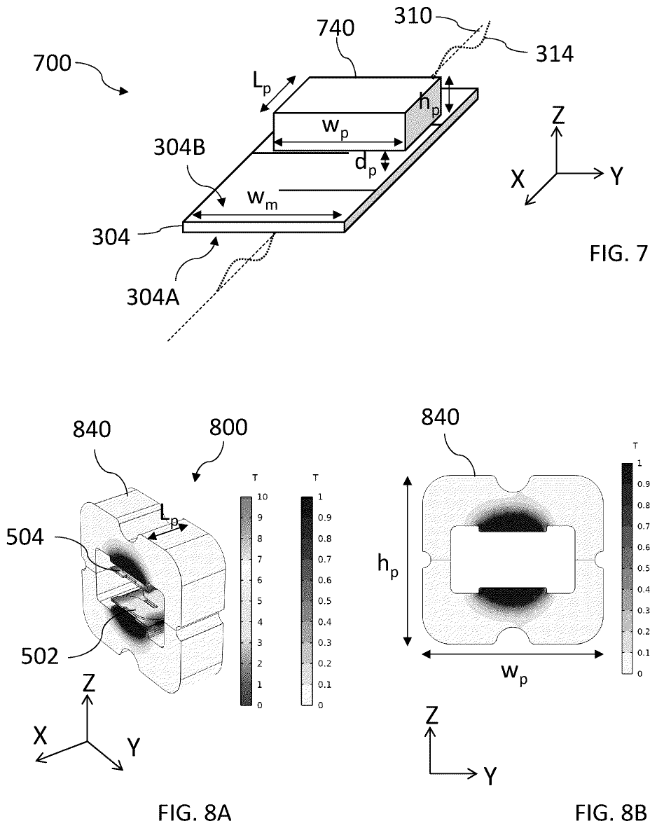

FIG. 8A schematically illustrates, in a perspective view, a superconducting undulator 800 according to another embodiment having another device 840 for compensating Lorentz force. FIG. 8B schematically illustrates, in a cross-sectional view, the device 840 for compensating Lorentz force of FIG. 8A.

The device 840 of FIGS. 8A and 8B has another shape than the device 740 of FIG. 7, and is positioned differently with respect to the coil structures, here the pairs 502, 504 of coil structures of FIGS. 5A and 5B. The device 840 for compensating Lorentz force comprises, for example consists in, a ferromagnetic pole in the form of a collar, for example an iron collar, which surrounds the pairs 502, 504 of coil structures.

The width wₚ and the height hₚ of the ferromagnetic collar are adapted respectively to the width wₘ and the height hₘ of the pair of coil structures 502, 504. The length Lₚ of the iron collar can be lesser than the length of the pairs 502, 504 of coil structures.

It should be noted that the use of a ferromagnetic pole as illustrated in the embodiments of FIGS. 7, 8A, 8B aim at removing a mechanical load that could otherwise affect the superconducting structure, by compensating for the Lorentz force contribution. The ferromagnetic pole of the embodiments has a different functionality compared to the ferromagnetic poles used in the state of the art which are generally used to increase the amplitude of the magnetic field.

Moreover, the ferromagnetic pole of the embodiments does not penetrate through the superconducting coil structure, as it is generally the case in the state of the art. Instead, the ferromagnetic pole of the embodiments is positioned on or around the superconducting coil structure, which provides the functionality described above.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. An undulator device comprising:
at least a first superconducting coil structure; and
at least a second superconducting coil structure positioned opposite the first superconducting coil structure;
wherein the first and second superconducting coil structures are separated by a gap dedicated to the passage of an electron beam having an electron beam trajectory around a beam axis, the beam axis being in a first direction;
wherein each superconducting coil structure includes:
a plurality of grooves through the thickness of said superconducting coil structure to separate it into a plurality of elementary coils; the grooves being configured in such a way that an electrical current flowing in the superconducting coil structure between the grooves can flow alternately in two different orientations, for example into substantially two opposite orientations, in said superconducting coil structure; the grooves reaching at least one side of the superconducting coil structure; and
a plurality of supplementary grooves through the thickness of said superconducting coil structure, the supplementary grooves being positioned at a distance from the grooves, and being entirely contained inside the superconducting coil structure without reaching a side of the superconducting coil structure.

2. The undulator device according to claim 1, wherein the first and second superconducting coil structures extend in a direction substantially parallel to the first direction, and the gap is in a second direction substantially perpendicular to the first direction.

3. The undulator device according to claim 2, wherein the first and second superconducting coil structures are centered around the beam axis in the second direction, and preferably in a third direction perpendicular to the first and second directions.

4. The undulator device according to claim 2, wherein the alternative different orientations of the electrical current correspond to two opposite orientations in a third direction perpendicular to the first and second directions.

5. The undulator device according to claim 2, wherein the plurality of grooves extend in a third direction perpendicular to the first and second directions, the grooves being for example substantially straight.

6. The undulator device according to claim 1, wherein each of the grooves starts at a first side of the superconducting coil structure or a second side of the superconducting coil structure opposite the first side, and stops at a distance from respectively the second side or the first side of the superconducting coil structure, the first and second sides extending for example in the first direction.

7. The undulator device according to claim 6, wherein the grooves are regularly distributed in the first direction.

8. The undulator device according to claim 7, wherein the plurality of grooves comprises first grooves starting at the first side and stopping at a first distance from the second side, and second grooves starting at the second side and stopping at a second distance from the first side, the first and second grooves alternating, the first and second distances being for example equal.

9. The undulator device according to claim 1, wherein:
the dimension, in the first direction, of each groove is higher than or equal to 0.01 mm, for example higher than or equal to 0.05 mm; and/or
the dimension, in the first direction, of each elementary coil is less than or equal to 20 mm; and/or
the dimension, in a second direction parallel to the direction of the gap, of each superconducting coil structure is less than or equal to 10 mm, preferably less than or equal to 1 mm.

10. The undulator device according to claim 1, wherein the at least one second superconducting coil structure is adapted to be powered with an electrical current of equal polarity with regard to the electrical current adapted to be powered in the at least one first superconducting coil structure.

11. The undulator device according to claim 1, wherein the grooves of the at least one first superconducting coil structure are aligned in the first direction with the grooves of the at least one second superconducting coil structure.

12. The undulator device according to claim 1, wherein the supplementary grooves are substantially curved, for example following substantially the shape of electrical current lines between the grooves, and/or at least one of the supplementary grooves is in at least two parts.

13. The undulator device according to claim 1, wherein the at least one first superconducting coil structure is a first multi-structure comprising at least an inner and an outer first superconducting coil structures assembled together and the at least one second superconducting coil structure is a second multi-structure comprising at least an inner and an outer second superconducting coil structures assembled together, the first and second multi-structures being for example pairs, and for example similar pairs.

14. The undulator device according to claim 13, wherein:
the first, respectively the second, inner superconducting coil structure is longer or smaller than the first, respectively the second, outer superconducting coil structure; and/or
the first, respectively the second, inner superconducting coil structure has two end grooves and two end elementary coils more or less than the first, respectively the second, outer superconducting coil structure; and/or
the first, respectively the second, inner superconducting coil structure is offset in the first direction with respect to the first, respectively the second, outer superconducting coil structure, for example of a distance equal to the sum of the dimensions in the first direction of an elementary coil of the plurality of elementary coils and of one groove of the plurality of grooves which is adjacent to the elementary coil; and/or
the first outer superconducting coil structure, respectively the second outer superconducting coil structure, is powered with an electrical current of opposite polarity with regard to the electrical current powered in the first inner superconducting coil structure, respectively the second inner superconducting coil structure.

15. The undulator device according to claim 1, wherein:
each superconducting coil structure has at least a planar portion, preferably along the electron beam trajectory and/or
the plurality of elementary coils of each superconducting coil structure forms a serpentine shaped structure.

16. The undulator device according to claim 1, wherein each superconducting coil structure further comprises at least an electrical current path coupled to the plurality of elementary coils, the at least one electrical current path extending in the first direction, preferably two electrical current paths, one at each side, parallel to the first direction, of the plurality of elementary coils.

17. The undulator device according to claim 1, further comprising a device for compensating Lorentz force on the first and second superconductive coil structures, for example a ferromagnetic collar which surrounds said first and second superconductive coil structures.

18. The undulator device according to claim 1, wherein each superconducting coil structure comprises, for example consists in, a stacking (320) of different layers comprising:
a substrate layer, for example composed or covered by a material like Hastelloy;
at least a buffer layer, and preferably a plurality of buffer layers, on the substrate layer; the at least one buffer layer being for example conformed of materials like alumina, yttria, magnesium oxide and/or lanthanum manganite; and
a superconducting layer on the at least one buffer layer, the superconducting layer including a superconducting material or a material adapted to be superconducting under appropriate conditions like under a temperature limit, for example a rare-earth based material, like a rare-earth barium copper oxide, or an yttrium barium copper oxide;
the substrate layer including for example at least a canal, for example to enable a cooling fluid like nitrogen or helium flowing through the superconducting coil structure, and/or to allow wiring passing through the superconducting coil structure.

19. The undulator device according to claim 18, wherein the stacking comprises:
a repetition of the buffer and superconducting layers, preferably several repetitions, for example between 1 and 25 repetitions; and, possibly,
a repetition of the substrate layer and the repeated buffer and superconducting layers, preferably several repetitions, for example between 1 and 25 repetitions.
